(19) United States
(12) Patent Application Publication
(10) Pub. No.: US 2002/0052882 A1
(43) Pub. Date: May 2, 2002

(54) Method and apparatus for visualizing complex data sets

(76) Inventor: Seth Taylor, Cambridge, MA (US)

Correspondence Address: TESTA, HURWITZ & THIBEAULT, LLP, HIGH STREET TOWER, 125 HIGH STREET, BOSTON, MA, 02110, US

(21) Appl. No.: 09/903,392

(22) Filed: Jul. 9, 2001

Related U.S. Application Data
(60) Provisional application No. 60/216,902, filed on Jul. 7, 2000.
(60) Provisional application No. 60/217,873, filed on Jul. 12, 2000.

(51) Int. Cl. G06F 7/00

(52) U.S. Cl. 707/104.1

(57) ABSTRACT

A virtual microplate is provided. The microplate corresponds to a plurality of physical microplates, the virtual microplate comprising a first virtual well associated with a first physical well of a first physical microplate and a second virtual well associated with a second physical well of a second physical microplate.

### CROSS-REFERENCE TO RELATED APPLICATIONS

The present application claims benefit of U.S. Patent Application Ser. Nos. 60/216,902 and 60/217,873, filed Jul. 7, 2000 and Jul. 12, 2000, respectively, and is a continuation of U.S. Patent Application Ser. No. ______, filed on Jul. 6, 2001 under Attorney Docket Number MWR-004CN.

### FIELD OF THE INVENTION

The invention relates to the field of data management and, more specifically, to the field of visualizing complex, voluminous data sets.

### BACKGROUND OF THE INVENTION

Laboratory researchers must design and plan their experiments, perform the experiments, store and analyze experimental data, and generate reports based on raw and processed data. These experimental tasks are particularly challenging in fields that entail high volumes of samples or data. For example, biologists working in the fields of genetics and drug-discovery often employ high-throughput screening (“HTS”) where microassay samples have volumes in a range of picoliters to milliliters. In analogy to biological experiments done in test tubes, experiments done in microassays require liquid-handling steps to mix reagents in strict quantities and specified orders. Commonly, these HTS liquid-handling robots are employed to automate the preparation of thousands of microassay samples, often using microarrays, microplates, or DNA Chips. Data is often collected in the form of images for the thousands of samples, further increasing the difficult of managing experiments.

Sample tracking is the first challenge in data management, followed by data collection, analysis and reporting. The quantity and complexity of experiments achievable by these HTS research techniques far exceed the laboratory worker's ability to efficiently manually manage experimental information. This presents significant challenges in experimental design, sample tracking, and experimental data collecting, tracking and analysis. These challenges are particularly acute in microassy research which can require the analysis of hundred or thousands of individual results. There exists a need to organize, arrange, and display for evaluation voluminous, complex data sets from microassay research in an efficient and lucid manner.

### SUMMARY OF THE INVENTION

In one embodiment the invention relates to a virtual microplate corresponding to a plurality of physical microplate. The virtual microplate includes a first virtual well and a second virtual well. The first virtual well is associated with a first physical well of a first physical microplate. The second virtual well is associated with a second physical well of a second physical microplate. The physical microplates to which the virtual wells correspond may be geographically remote from one another. In other embodiments, each virtual well has a number of attributes associated with it that indicates information corresponding to the physical well to which the virtual well corresponds.

In another embodiment, the present invention relates to a method for visualizing data. A first data array and a second data array are provided, each of the data arrays have a plurality of locations which includes a plurality of attributes associated with each location. A virtual data array is generated which includes a plurality of locations, each location associated with a location from the first or second data and each location including a plurality of attributes associated with the location in the first or second data and each location including a plurality of attributes associated with the location in the first or second data array.

### BRIEF DESCRIPTION OF THE DRAWINGS

The advantages of the invention described above, together with further advantages, may be better understood by referring to the following description taken in conjunction with the accompanying drawings. In the drawings, like reference characters generally refer to the same parts throughout the different views. Also, the drawings are not necessarily to scale, the emphasis instead is placed on conveying the concepts of the invention.

FIG. 1 is a highly diagrammatic block diagram of a research environment in which the present invention may be used.

FIG. 2 is a block diagram depicting one embodiment of a virtual microarray.

FIG. 3 is a screen shot depicting an embodiment of the invention.

FIG. 4 is a screen shot depicting an embodiment of the invention.

FIG. 5 is a screen shot depicting an embodiment of the invention.

FIG. 6 is a screen shot depicting an embodiment of the invention.

FIG. 7 is a screen shot depicting an embodiment of the invention.

### DETAILED DESCRIPTION OF THE INVENTION

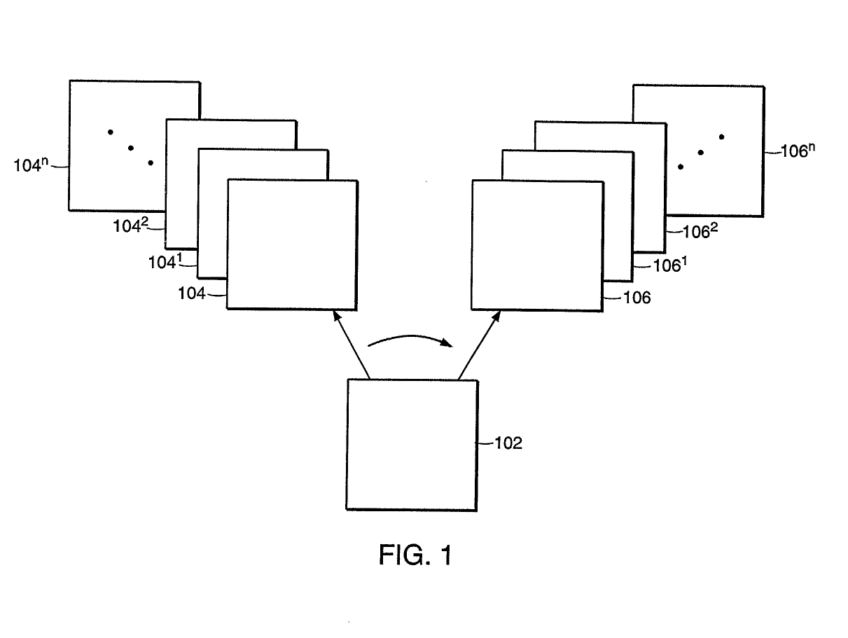

FIG. 1 depicts a research environment in which the present invention may be used. A microarray robot 102 transfers biological samples from microplates 104, 104¹, 104², . . . , 104ⁿ (generally 104) to microarrays 106, 106¹, 106², . . . , 106ⁿ (generally 106). Although the example shown in FIG. 1 depicts an equal number of microplates and microarrays, the number of microplates does not need to equal the number of microarrays. Each individual sample in a microplate is referred to as a “well” and each microplate may have 96, 384, or 1536 wells. Individual areas on a microarray 106 which receive biological sample material are referred to as “spots.” The number of spots on each microarray 106 is limited solely by the size of the physical media comprising the microarray 106 and the proximity with which biological samples may be placed to one another by the microarray robot 102. Exemplary microarray robots 102 that may be used include: the Biochip Arrayer I and the Biochip Arrayer II, manufactured by Packard BioScience of Meriden, Connecticut; the GTM-STP-1218, manufactured by Nippon Laser and Electronics Lab of Nagoya, Japan; the OmniGrid manufactured by GeneMachines of San Carols, Calif.; the Pixsys 5500 manufactured by Cartesian Technologies of Irvine, Calif.; the 417 manufactured by Affymetrix of Santa Clara, Calif., and the MicroGrid II manufactured by BioRobotics of Cambridge, United Kingdom.

In some embodiments, software implementing the present invention may run directly on a microarray robot 102. In other embodiments, software implementing the present invention may run on a computing node (not shown) that is in communication with the microarray robot 102. In these embodiments, the computing node may be any personal computer (e.g., 286, 386, 486, Pentium, Pentium II, Macintosh computer), Windows-based terminal, Network Computer, wireless device, information appliance, RISC Power PC, X-device, workstation, mini computer, main frame computer or other computing device. Windows-oriented platforms supported by the computing node can include Windows 3.x, Windows 95, Windows 98, Windows NT 3.51, Windows NT 4.0, Windows CE, Macintosh, Java, Unix and Windows 2000. The computing node can include a display screen, a keyboard, memory for storing downloaded application programs, a processor, and a mouse. The memory can provide persistent or volatile storage. In other embodiments, the computing node may be provided as a personal digital assistant (PDA), such as the Palm series of PDAs, manufactured by Palm, Inc. of Santa Clara, Calif. In these embodiments, the computing node may communicate with the microarray robot 102 using infrared links. In one particularly preferred embodiment, the computing personal computer node is a personal computer including a PENTIUM III processor (or better) using MICROSOFT WINDOWS 4.0 or MICROSOFT WINDOWS 2000 (or better).

The computing node includes, or has access to, a database for storing information relating to individual spots and wells. The database may be a relational database such as the Oracle 9i database, manufactured by Oracle Corporation of Breadwood Shores, Calif. Alternatively, the database may be a flat filed database such as the JET database manufactured by Microsoft Corporation of Redmond, Wash. In other embodiments the computing node may store information relating to wells and spots in a flat file or, delimited, -delimited format. In further embodiments the database may be any OTBC-compliant database.

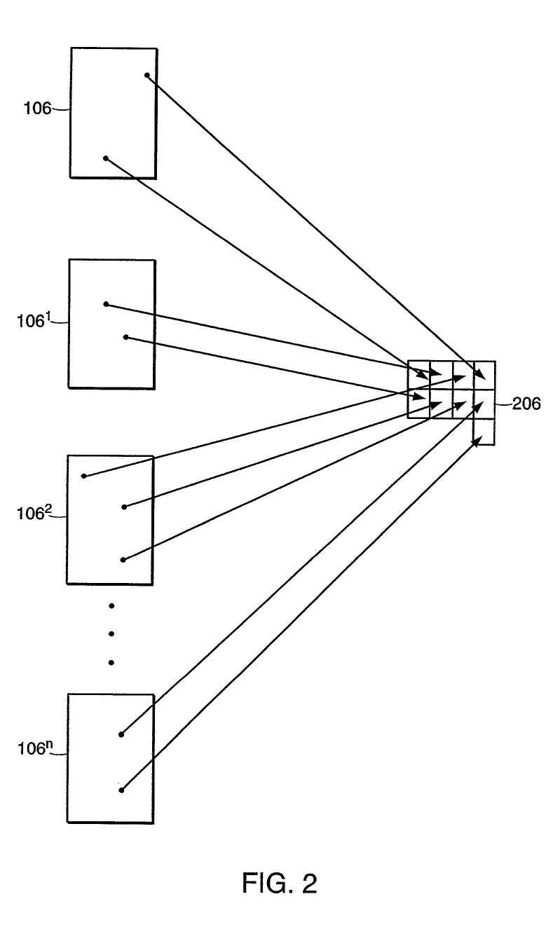

FIG. 2 depicts an embodiment of a virtual microarray 206. Each spot on virtual microarray 206 corresponds to a physical spot on a physical microarray 106. Although FIG. 2 depicts a virtual microarray 206, the virtual microplates may also be constructed from one or more wells from a physical microplate 104. The assignment of physical spots to virtual spots in virtual microarray 206 may be selected by the user, either by specifying a search criteria that operates on data representing the physical spots, or by manual selection. For embodiments in which the user specifies a search criteria, the search results may form virtual microarray 206, which allows a user to combine physical spots from multiple physical microarrays 106 that share a common data characteristic, regardless of the geographic or temporal location of the physical spot. As shown in FIG. 2, virtual microarray 206 does not need to have the same geometric characteristics as the physical microarrays 106 from which it is constructed. Also as shown in FIG. 2, virtual microarray 206 need not have a regular geometric shape.

In order to facilitate the construction of virtual microarray 206 (and also virtual microplates or other virtual constructs which are hybrids of physical microplates and physical microarrays) a data object may be created which represents physical microarray 106. In some embodiments, a base class may be provided which generally represents physical microarrays 106. Each physical microarray 106 is modeled as an instantiation of that base class. In one particular embodiment, a base class representing a physical microarray 106 or microplate 104 provides:

(1) an internal variable indicating whether the object represents a microplate 104 or a microarray 106;

(2) one or more attributes of the physical microplate or microarray, which may be defined by the researcher;

(3) information about the geometric layout of the physical microplate or microarray, such as the spacing between wells/spots, and whether wells/spots are grouped into sets;

(4) well/spot attributes for each spot/well, which may be defined by the researcher;

(5) sample tracking information about each spot/well indicating both source and destination spot/wells;

(6) geometrical information about each spot of each image associated with the rack, such as detection status information, location, shape or contour, extents, compactness and confidence; and

(7) intensities for each spot of each image associated with the rack.

A companion class may be created which represents virtual versions of physical microarrays or microplates. In some embodiments, the class representing the virtual microarrays or microplates is an extension of the base class described above. In other embodiments, the class representing the virtual microarrays or microplates is a separate class. In one particular embodiment, a class representing a virtual microarray 106 or microplate 104 provides: (1) an internal variable indicating whether the object represents a virtual microarray or a virtual microplate; (2) information about the geometric layout of the virtual microplate or microarray; (3) well/spot attributes for each virtual well/virtual spot, which includes information about the physical well/physical spot and physical microplate/physical microarray it represents; (4) the search criteria used to identify each well/spot.

A class representing a virtual microplate or microarray should support the following actions: creation; display of the virtual microplate or microarray; display of virtual spots or virtual wells; selection of virtual spots or virtual wells; search refinements; deletion of virtual wells and virtual spots; deletion of virtual microplates or microarrays; and saving and loading virtual microplates and microarrays to and from a database.

A virtual microplate or microarray should be created as the result of a selection of wells or spots either manually or by search process. The dimensions of a virtual microplate or microarray (i.e., rows and columns) should be computed (or recomputed) as necessary.

A virtual microplate or microarray should be displayed to the user in a fashion that is analogous to the display of a physical microarray or microplate or robot deck.

Individual spots and wells should be drawn to reflect a user-indicated properties through shading or color coding. For example, a researcher may have searched for all spots having an intensity above a minimum value and below a maximum value. Spots matching that search criteria can be displayed with a color map reflecting the actual intensity value.

Virtual wells and virtual spots may be selected with standard mouse clicking and dragging. Attributes of those virtual wells or virtual spots should be displayed when a particular virtual well or virtual spot is selected. This allows a researcher to edit attributes or annotations of attributes by selecting a virtual well or virtual spot to display the attributes of that virtual well or virtual spot. In some embodiments, when virtual wells or virtual spots are selected they are highlighted and a graphical representation of the physical well or physical spot to which they correspond should also be displayed.

The researcher may use all or a subset of the virtual wells or virtual spots to refine a search and generate additional virtual microplates or microarrays as the result of the searches. For each search iteration, the search criteria and search results should be saved.

A researcher should be allowed to delete a virtual well or virtual spot by selecting a virtual well or virtual spot and indicating to the computing device that the virtual well or virtual spot should be deleted. When this occurs, the virtual well or virtual spot is removed from the virtual microplate or virtual microarray.

The researcher should also be allowed to delete and entire virtual microplate or microarray by selecting the virtual microplate or microarray and indicating that it should be deleted.

Virtual microplates and microarrays should be able to be stored. In some embodiments, virtual microplate and microarrays are stored in a database.

A virtual array may have 1, 10, 20, 40, 80, 160, 250, 500, 1000, 10000, 100000, 1000000, 10000000 or more spots or wells. A virtual array or plate contains a CArray (Microsoft Foundation Class construct) of spots or wells. CArrays are indexed by integers so in the 32-bit world the current maximum number of virtual spots or wells that we could have associated with a single virtual array or plate is INT_MAX or 2147483647. In a 64-bit world, INT_MAX for a virtual array is 4611686014132420609.

Avirtual array may have 1, 10, 20, 40, 80, 160, 250, 500, 1000, 10000, 100000, 1000000, 10000000 or more attribute field linked to each spot or well of a virtual array. By changing one line of code we can increase the number of attribute fields linked to a spot or well to practically any multiple of 32. We have a # define called ROLLCALL_SIZE in AttributeList.h which determines the number of multiples of 32. Therefore the total number of attributes per object is the sum of the number of built-in attributes.

A virtual array may contain links back to spots or wells from 1, 10, 20, 40, 80, 160, 250, 500, 1000, 10000, 100000, 1000000, 10000000 or more different virtual arrays, microplates or microarrays. Each spot or well in a virtual array may come from one well or spot of a linked virtual array, microarray or microplate. A virtual array or plate contains a CArray (Microsoft Foundation Class construct) of spots or wells. CArrays are indexed by integers so in the 32-bit world the current maximum number of different microplates, microarrays or virtual arrays that we could have associated with a single virtual array or plate is INT_MAX or 2147483647. In a 64-bit world, INT_MAX for a virtual array is 4611686014132420609.

A researcher should be allowed to order the numbering of the virtual wells or spots in a virtual array based on their attributes. In one embodiment, the ordering of the virtual spots or wells in a virtual array is based on a numerical value described in a common attribute field for each of the virtual spots or wells. For example, the researcher can order the virtual spots or wells in a virtual array from left to right starting with the highest numbers first. In other embodiments, the ordering of the virtual spots or wells in a virtual array is based on an alphabetical ordering of a word or alphanumeric descriptor found in a common attribute field for each of the virtual spots or wells. For example, the researcher may order the virtual spots or wells in a virtual array from left to right starting with A and ending with Z based on a word found in a common attribute field. In other embodiments, the ordering of the virtual spots or wells in a virtual array may be based on a set of user-defined rules that use a word, number, or alphanumeric descriptor found in a common attribute field for each of the virtual spots or wells. For example, the ordering of the virtual spots or wells in a virtual array may be determined by user-defined rules that break the virtual spots or wells in a virtual array into groups based on a common attribute and then orders these groups from left to right. In another embodiment, the ordering of the virtual spots or wells in a virtual array may be determined by a word, number, or alphanumeric descriptor found in two or more common attribute fields in combination. For example, a set of virtual spots or wells in a virtual array is first ordered alphabetically from A to Z using a word found in the first attribute field, and then sorted numerically starting with one using a number found in the second attribute field.

A researcher should be allowed to modify the shape or shading of a virtual spot or well based on the attributes of a virtual well or spot included in the virtual array. In one embodiment, a virtual spot or well in a virtual array may be shaded based on the numerical value contained in an attribute field. In another embodiment, each virtual spot or well in a virtual array may have the appearance of a three dimensional rectangle with the same base dimensions but a height determined by the numerical value in one of the common attribute fields. In another embodiment, the two dimensional shape of each virtual spot or well of a virtual array may be defined by the value contained in a common attribute field. For example, a common attribute field may contain one of four values, and each attribute value is associated with a unique shape for the virtual spot or well, e.g. circle, square, triangle or hexagon.

Virtual arrays may provide pop-up views of the data associated with a virtual well or spot when a mouse hovers over the virtual spot or well. In one embodiment, the popup view may display one or more attributes at the same time. In other embodiments, one or more attribute values may be displayed for a defined period of time, where the first attribute value is displayed followed by the next attribute value until all the attribute values have been displayed. In other embodiments, attribute values for a group of virtual spots or wells in a virtual array may be displayed in a pop-up view together when a mouse hovers over one virtual spot or well of the group. For example, the virtual spots or wells of a virtual array may be grouped based on a common attribute value, e.g. attribute Gene Name contains value of Sp1, and all the virtual spots or wells with the specified attribute value display data from one or more attribute fields in a pop-up view when the mouse hovers over any virtual spot or well containing the specified attribute value.

The researcher may generate various tables, graphs and reports based on the data contained in one or more the attributes of a virtual array. In one embodiment, the attributes may be displayed in a table that contains one or more attributes from the virtual array in the rows or columns of the table. In another embodiment, the attributes may be displayed in a graph that displays the data graphically based on one or more attributes. For example, the data may be displayed in a scatter plot based on the data in one or more common attributes. In another embodiment, the researcher may generate a report that describes one or more attributes for a selected group of virtual spots or wells in a virtual array. The report may be a template that contains fields that are filled out based on information contained in the attributes of a virtual array. In another embodiment, the researcher can modify values in the virtual spots or wells of a virtual array through the fields displaying data in the tables, graphs, and reports generated from the virtual array.

Virtual arrays may provide a means to select attribute data in spots or wells of virtual arrays, microplates, and microarrays for automatic updating over the Web or Internet. In one embodiment, the attribute data of one or more virtual spots or wells of a virtual array are selected and the researcher then defines the source of the updates and the frequency of updating. The updates may arrive as files for import into the application or the updates may be written directly to the database. In another embodiment, the researcher may create links from one or more attribute fields of a spot or well in a virtual array, microplate, or microarray to a Web site that contains data. The data on the Web site may be updated and viewed from the virtual array using software (e.g. an embedded Web browser such as Explorer™ from Microsoft).

Virtual arrays may provide for data export from or import to spot and/or well attributes associated with virtual arrays, plates, and microarrays. Export and import may be performed to and from a web page, a Web-based search engine, a report, another software application, a robotic or other hardware interface, or another content management system. In one embodiment, the import and export of data is mediated by a standard data transfer format, e.g. Extensible Markup Language (XML). In another embodiment, data from one or more attributes of a virtual array may be exported into and imported from an application for visualization of microarray data, e.g. Array Explorer™ software from Spotfire of Cambridge, Mass. and GeneSpring™ software from Silicon Genetics of Redwood City, Calif. For example, a researcher may select data from one of more attributes in a virtual array for export to a visualization software package (e.g. GeneSpring™ from Silicon Genetics of Redwood City, Calif.), the data from the virtual array will then be viewed in this visualization software by one or more researchers where the data from the virtual array may be modified, and then the modified data from the virtual array in the visualization software may be imported from the visualization software back into the original virtual array or used to create a new virtual array by a researcher. In another embodiment, data from one or more attributes of a virtual array may be exported to and imported from robotic control software to specify the aspiration and dispensing procedures for a robot, using a flat file format readable by both software packages (e.g. XML or text file formats). For example, a researcher may create a virtual array from spots or wells from microarrays, microplates and virtual arrays where data from one of more attributes met certain criteria, e.g. ratio data from two images generated from the microarray (e.g. Cy3 and Cy5) exceeded a threshold value, or the quality of an assay component in a microplate or microarray met or exceeded a certain value (e.g. including but not limited to components such as DNA, protein, chemicals, carbohydrates, buffers, dyes, isotopes). The data from this virtual array may be used by the researcher to specify the manufacture of a new microarray using a robot, e.g. Biochip Arrayer I and the Biochip Arrayer II, manufactured by Packard BioScience of Meriden, Connecticut; the GTM-STP-1218, manufactured by Nippon Laser and Electronics Lab of Nagoya, Japan; the OmniGrid manufactured by GeneMachines of San Carols, Calif.; the Pixsys 5500 manufactured by Cartesian Technologies of Irvine, Calif.; the 417 manufactured by Affymetrix of Santa Clara, Calif., and the MicroGrid II manufactured by BioRobotics of Cambridge, United Kingdom. In another embodiment, data from one or more attributes in a virtual array may be exported to or imported from a report template generated in a Web page format (e.g. GeneNet™ from Silicon Genetics of Redwood City, Calif.) using a flat file format readable by both software packages (e.g. XML or text file formats). For example, a researcher may select data from one of more attributes in a virtual array for export to a Web page report format, the data from the virtual array will then be viewed in this report by one or more researchers where the data from the virtual array may be modified, and then the modified data from the virtual array in the Web page report format may be imported back into the original virtual array or used to create a new virtual array by a researcher. In another embodiment, the researcher may import to or export from a virtual array to a content management system (e.g. including but not limited to DigitalGENOME software from Molecularware of Cambridge, Mass.; Genomax software from Informax of California; Resolver™ from Rosetta Inpharmatics of Kirkland, Wash.; DoubleTwist.com Web site from DoubleTwist.com of Oakland, Calif.), using a flat file format readable by both software packages (e.g. XML or text file formats) or a software script that writes to and from the databases incorporated with the content management software.

Virtual arrays may provide a data set for the application of mathematical and/or other statistical based analysis on information contained in attributes of spots and/or wells of virtual arrays, microplates and microarrays. The mathematical and/or statistical analysis that may be applied to spots and/or wells of virtual arrays, microplates or microarrays includes but is not limited to data mining, data normalization, data reduction or data quality analysis. In one embodiment, the researcher may create a virtual array from one or more spots or wells from one or more microplates, microarrays and virtual arrays. The information contained in the attributes of a virtual array (e.g. data points, confidence analysis, information on controls and/or experimental replicates) may be used as a dataset to perform statistical normalization techniques (e.g. removal of artifacts, subtraction of background, measures of the middle (central tendency), measures of spread (dispersion), measures to describe relationships between two characteristics, measurements of variation in the data, measurements of reliability and validity, measurements of error propagation). Examples of data normalization statistical outcomes include but are not limited to normalized weighted average log data sets and normalized weighted average ratio data sets. These data sets can be used to derive statistical measures of data quality, including but not limited to outlier analysis and spot to spot variation, that may be used by the researcher to remove poor data points from further analysis. The statistical normalization applied to a virtual array may allow the researcher to directly compare data from the spots or wells of the different microplates, microarrays and virtual arrays that comprise a virtual array and may enable the researcher to create a dataset or new virtual array for use in other mathematical and/or statistical techniques (e.g. data mining, data normalization, data reduction or data quality analysis). In another embodiment, the researcher may create a virtual array from one or more spots or wells from one or more microplates, microarrays and virtual arrays. The information contained in spot or well attributes of virtual arrays, microplates or microarrays linked to the spots or wells of a primary virtual array (e.g. information on controls or experimental replicates) may be used as a data set to perform statistical normalization techniques (e.g. removal of artifacts, subtraction of background, measures of the middle (central tendency), measures of spread (dispersion), measures to describe relationships between two characteristics, measurements of variation in the data, measurements of reliability and validity, measurements of error propagation). The links between the virtual arrays, microplates and microarrays and the primary virtual array may be internal to the software and/or database, or mediated through a network (e.g. LAN, WAN, Internet). Examples of data normalization statistical outcomes include but are not limited to normalized weighted average log data sets and normalized weighted average ratio data sets. These data sets can be used to derive statistical measures of data quality, including but not limited to outlier analysis and spot to spot variation, that may be used by the researcher to remove poor data points from further analysis. The statistical normalization applied to a primary virtual array may allow the researcher to directly compare data from the spots or wells of the different microplates, microarrays and virtual arrays that comprise the primary virtual array and may enable the researcher to create a data set by filling attribute fields of the virtual array or by generating a new virtual array for use in other mathematical and/or statistical techniques (e.g. data mining, data normalization, data reduction or data quality analysis). In other embodiments, the researcher may create a virtual array from one or more spots or wells from one or more microplates, microarrays and virtual arrays. The information contained in the attributes of a virtual array (e.g. data points, confidence analysis, information on controls and/or experimental replicates) may be used as a data set to perform statistical normalization with third party software applications. Data from one or more attributes linked to the spots or wells of a virtual array may be exported in a form readable by to a software package (e.g. XML or text file formats), including but not limited to Statistical Informatics™ from Imaging Research of Ontario, Canada, and the results of the normalization process may be imported back into the attribute fields of the original virtual array or into the attribute fields of a new virtual array for use with other statistical analysis and data mining procedures. In other embodiments, the researcher may create a virtual array from one or more spots or wells from one or more microplates, microarrays and virtual arrays. The information contained in the attributes of a virtual array (e.g. data points, confidence analysis, information on controls and/or experimental replicates) may be used to generate a data set to perform statistical data mining techniques. Examples of statistical data mining techniques that may be applied to data sets generated from virtual arrays includes but is not limited to support vector machines, K-means analysis, hierarchical clustering analysis, principal component analysis, self-organizing maps, mutual relevancy networks, PLAID models, Bayesian networks, independent component analysis, etc. In other embodiments, the researcher may create a virtual array from one or more spots or wells from one or more microplates, microarrays and virtual arrays. The information contained in the attributes of a virtual array (e.g. data points, confidence analysis, information on controls and/or experimental replicates) may be used as a data set to perform data mining with third party software applications. Data from one or more attributes linked to the spots or wells of a virtual array may be exported in a format (e.g. XML or text file formats) readable by data mining software packages including but not limited to Statistical Informatics™ from Imaging Research of Ontario, Canada; GenExplore™ from Applied Maths of Sint-Martens-Latem, Belgium, GeneSight™ from Biodiscovery of Los Angeles, Calif.; Cluster/TreeView from Eisen-Stanford University of Stanford, Calif.; Expressionist from GeneData of Basel, Switzerland; Resolver™ from Rosetta Inpharmatics of Kirkland, Wash.; Genespring™ from Silicon Genetics of Redwood City, Calif.; Spotfire Array Explorer from Spotfire of Cambridge, Mass.; etc. The results of the data mining process may be imported back into the attribute fields of the original virtual array or into the attribute fields of a new virtual array for use with other statistical analysis and data mining procedures.

The researcher may generate a purchase or product ordering request (possibly through integration with an ERP system) based on the content contained in the virtual arrays, plates, spots and/or wells. In one embodiment, the researcher may create a virtual array from one or more spots or wells from one or more microplates, microarrays and virtual arrays. The information contained in the attributes of a virtual array may be used to create a requisition request for one or more items including but not limited to reagents, chemicals, microarrays (e.g. bioassay, reagent, DNA, protein, chemical, carbohydrate, etc.), microplates (e.g. bioassay, reagent, DNA, protein, chemical, carbohydrate, etc.), hardware, disposables. The requisition request may be generated in a format (e.g. XML or text file formats) readable by Enterprise Resource Planning (ERP) software used for making and tracking purchase requests and managing inventories. Examples of ERP software include but are not limited to EMAX Substance Manager and EMAX Reagent Manager from EMAX Solutions a subsidiary of SciQuest of Morrisville, N.C. In other embodiments, the researcher may create a virtual array from one or more spots or wells from one or more microplates, microarrays and virtual arrays. The information contained in the attributes of a virtual array may be used to create a requisition request for one or more items including but not limited to reagents, chemicals, microarrays (e.g. bioassay, reagent, DNA, protein, chemical, carbohydrate, etc.), microplates (e.g. bioassay, reagent, DNA, protein, chemical, carbohydrate, etc.), hardware, disposables. The requisition request may be generated in a format (e.g. XML or text file formats) readable by e-commerce software that runs over the Internet. Examples of e-commerce software include but are not limited to SciQuest.com from SciQuest of Morrisville, N.C.

As described above, both classes support inclusion of one or more attributes that may be specified by the researcher. Exemplary attributes include:

(1) an Array/Plate Name: This field is read-only and displays the name of the selected array(s) or plates(s);

(2) Array/Plate ID: This field displays the unique ID (barcode) of the selected array(s) or plate(s);

(3) Parent ID: This attribute is used to keep track of which array or plate is parent and which is daughter; it will be set to “None” if there is no parent, and to the value of the parent's “Array/Plate ID” if there is a parent;

(4) Images: This field is read-only and displays the labels of all images associated with the selected array(s); Comments: This field stores comments;

(5) X Offset (μm): This field is read-only and specifies the horizontal offset of the top left well center from the Deck View's left edge;

(6) Y Offset (μm): This field is read-only and specifies the vertical offset of the top left well center from the Deck View's top edge;

(7) Columns of Multi-Sets: This field is read-only and specifies the number of columns of secondary array combinations for the selected array(s) or plate(s);

(8) Rows of Multi-Sets: This field is read-only and specifies the number of rows of secondary array combinations for the selected array(s) or plate(s);

(9) Multi-Set Column Spacing (μm): This field is read-only and specifies the horizontal center-to-center spacing between elements of all multi-sets within the selected array(s) or plate(s);

(10) Multi-Set Row Spacing (μm): This field is read-only and specifies the vertical center-to-center spacing between elements of all multi-sets within the selected array(s) or plate(s);

(11) Columns of Sets: This field is read-only and specifies the number of columns of secondary arrays for the selected array(s) or plate(s);

(12) Rows of Sets: This field is read-only and specifies the number of rows of secondary arrays for the selected array(s) or plate(s);

(13) Set Column Spacing (μm): This field is read-only and specifies the horizontal center-to-center spacing between elements of all secondary arrays within the selected array(s) or plate(s);

(14) Set Row Spacing (μm): This field is read-only and specifies the vertical center-to-center spacing between elements of all secondary arrays within the selected array(s) or plate(s);

(15) Columns per Set: This field is read-only and displays the number of columns per set in the selected array(s) or plate(s);

(16) Rows per Set: This field is read-only and displays the number of rows per set in the selected array(s) or plate(s);

(17) X Spacing between Wells (μm): This field is read-only and specifies the horizontal spacing between wells in the selected array(s) or plate(s);

(18) Y Spacing between Wells (μm): This field is read-only and specifies the vertical spacing between wells in the selected array(s) or plate(s);

(19) Well Diameter: This field is read-only and specifies the diameter or width of each well in the selected array(s) or plate(s);

(20) Well Shape: This field is read-only and specifies the shape of all elements in the selected array(s) or plate(s);

(21) Grid Angle: This field specifies the angle of rotation (in degrees) of the grid(s) associated with the array. Positive angles correspond to clockwise rotations;

(22) Shape Constraint: This field specifies the spot shape used to represent the spot for intensity calculations. The shape choices are: Fixed, Fitted Min, Fitted Max, and Contour;

(23) Max Grid Rotation (deg): Specifies the maximum angle in degrees that the grid associated with an array can rotate;

(24) Max Set Deviation: Specifies the maximum deviation allowed for a set of Grid Spots (spot boundaries), starting from its nominal (template defined) position;

(25) Max Spot Deviation: Specifies the maximum deviation allowed for a spot;

(26) Min Spot Diameter: Specifies the minimum tolerated spot diameter value;

(27) Max Spot Diameter: Specifies the maximum tolerated spot diameter value;

(28) Max Spot Compactness: Specifies the maximum tolerated spot compactness. Compactness is a measure of the circularity of a spot. Note that a circle, which is the most compact shape, has a compactness of zero (0);

(29) Treatment: This field displays the Treatment variable;

(30) Treatment Units: This field displays the Treatment Units (i.e. time, concentration, etc.) of the selected array(s) or plate(s);

(31) Time: This field displays the time elapsed during hybridization, in minutes;

(32) Temperature: This field displays the temperature during hybridization, in degrees Celsius;

(33) Buffer: This field specifies the buffer used during hybridization;

(34) Cy3 ID: This field contains linked annotations and specifies the identification code of the dye;

(35) Cy3 cye dye: This field is linked to Cy3 ID and specifies the name of the dye;

(36) Cy3 enzyme: This field is linked to Cy3 ID and specifies the enzyme of the dye;

(37) Cy5 ID: This field contains linked annotations and specifies the identification code of the dye;

(38) Cy5 cye dye: This field is linked to Cy5 ID and specifies the name of the dye;

(39) Cy5 enzyme: This field is linked to Cy5 ID and specifies the enzyme of the dye;

(40) Filename: This field is read-only and stores the local filename of the selected image;

(41) Label: This field is read-only and displays a unique descriptor for the selected image. The scope of the unique descriptor is local to each array/plate;

(42) Width (μm): This field specifies the nominal width of the primary array of the selected image(s);

(43) Height (μm): This field is read-only and specifies the nominal height of the primary array of the selected image(s);

(44) Columns of Multi-Sets: This field is read-only and specifies the number of columns of secondary array combinations for the selected array(s) or plate(s);

(45) Rows of Multi-Sets: This field is read-only and specifies the number of rows of secondary array combinations for the selected array(s) or plate(s);

(46) Columns of Sets: This field is read-only and specifies the number of columns of secondary arrays for the selected image(s);

(47) Rows of Sets: This field is read-only and specifies the number of rows of secondary arrays for the selected image(s);

(48) Spot Diameter (μm): This field is read-only and specifies the spot diameter of all spots in the selected image(s);

(49) X Offset (pixels): This field specifies the horizontal offset of this image relative to other images in the same array;

(50) Y Offset (pixels): This field specifies the vertical offset of this image relative to other images in the same array;

(51) Comments: This field stores comments;

(52) Background type: This field specifies the way that background intensity values are calculated;

(53) Filter: This field specifies the type of prefilter applied to the image;

(54) Has Control Spots: This field indicates whether certain spots on the image represent experimental controls, as opposed to experimental unknowns. If an image has control spots, then a well on the image's array or plate that is annotated “may be a control spot” is in fact a control spot, for that particular image;

(55) Spot Confidence Threshold: Minimum confidence level, below which a spot is considered abnormal or of bad quality;

(56) Background Mean On: Specifies whether the Background Mean confidence metric is turned on or off;

(57) Max Background Mean: Specifies the maximum allowed background mean, below which the confidence decreases. Note that in order for there to be spot background mean values for this metric to work with, a background calculation method has to be turned on in the Project Settings before the image of interest is analyzed or in the Image Annotations after image analysis;

(58) Background Mean Window: Specifies the window of values within which the confidence decreases with respect to this metric;

(59) Background SD On: Specifies whether the Background Standard Deviation confidence metric is turned on or off;

(60) Max Background SD: Specifies the maximum permitted background standard deviation, below which the confidence decreases. Note that in order for there to be spot background standard deviation values for this metric to work with, a background calculation method has to be turned on in the Project Settings before the image of interest is analyzed or in the Image Annotations after image analysis;

(61) Background SD Window: Specifies the window of values within which the confidence decreases with respect to this metric;

(62) Signal CV On: Specifies whether the Signal Coefficient of Variance confidence metric is turned on or off;

(63) Max Signal CV: Specifies the maximum acceptable percentage of the signal coefficient of variance, below which the confidence decreases;

(64) Signal CV Window: Specifies the window of values within which the confidence decreases with respect to this metric;

(65) Saturated Pixels On: Specifies whether the Saturated Pixels confidence metric is turned on or off;

(66) Max Saturated Pixels: Specifies the maximum allowed percentage of saturated pixels in a spot, below which the confidence decreases;

(67) Saturated Pixels Window: Specifies the window of values within which the confidence decreases with respect to this metric;

(68) SNR On: Specifies whether the Signal To Noise Ratio confidence metric is turned on or off;

(69) Min SNR: Specifies the minimum tolerated percentage of the signal to noise ratio, above which the confidence decreases. By definition, this ratio is equal to the mean signal over the signal standard deviation;

(70) SNR Window: Specifies the window of values within which the confidence decreases with respect to this metric;

(71) Scanner ID: This field contains linked annotations, and specifies the identification code of the scanner used to capture the microarray images;

(72) Scanner operator: This field specifies the scanner operator;

(73) Scanner date: This field specifies the date when the image was captured;

(74) Number: This field is read-only and displays the absolute number of the selected well(s);

(75) Name: This field stores a meaningful name for the selected well(s) or spot(s);

(76) Array/Plate: This field is read-only and displays the array or plate name of the selected well(s);

(77) Multi-Set: This field is read-only and displays the number or alphabetic character of the selected well's multi-set;

(78) Multi-Set Row: This field is read-only and displays the number or alphabetic character of the selected well's multi-set row;

(79) Multi-Set Column: This field is read-only and displays the number or alphabetic character of the selected well's multi-set column;

(80) Set: This field is read-only and displays the number or alphabetic character of the selected well's set;

(81) Set Row: This field is read-only and displays the number or alphabetic character of the selected well's set row;

(82) Set Column: This field is read-only and displays the number or alphabetic character of the selected well's set column;

(83) Row: This field is read-only and displays the number or alphabetic character of the selected well's row;

(84) Column: This field is read-only and displays the number or alphabetic character of the selected well's column;

(85) Comments: This field stores comments;

(86) Clone ID: This field contains linked annotations and specifies the identification code of the clone or sample in the well or spot. All the other annotations in this tab are linked to the Clone ID;

(87) UniGene cluster ID: This field specifies the UniGene cluster identification code of the gene in the well or spot;

(88) Gene symbol: This field specifies the abbreviated name of the gene in the well or spot;

(89) Locus ID: This field specifies the identification code of the locus that corresponds to the gene in the well or spot;

(90) Chromosome ID: This field specifies the chromosome in which the gene in the sample is located;

(91) GenBank accession number: This field specifies the GenBank identification code of the gene in the well or spot;

(92) Tissue: This field specifies the tissue from which the sample was extracted;

(93) Gene map: This field specifies the genetic map of the gene in the well or spot;

(94) Gene name: This field specifies the unabbreviated name of the gene in the well or spot;

(95) Organism: This field specifies the organism from which the sample was extracted;

(96) Sequence: This field specifies the nucleotide sequence of the gene in the well or spot;

(97) Flagged As: This field indicates whether the user has specifically marked the selected well(s) as being abnormal in some way;

(98) Control Spot: This field indicates whether a well may be a control spot. The well will only be a control spot for those particular images that are attached to the well's array/plate and listed in their annotations as having control spots. Control spots can be set as either negative or positive controls;

(99) Spot Confidence: This field is read-only and indicates the confidence of the spot, as defined by the confidence metrics;

(100) Spot Normalized Intensity: This field is read-only and contains the normalized intensity of the spot as defined by the project settings;

(101) Spot Ratio: This field is read-only and contains the ratio of the normalized spot intensities, and it uses the selected image (e.g. cy3 or cy5) as the numerator;

(102) Spot Mean Intensity: This field is read-only and stores the mean signal intensity value(s) of the selected spot(s). This is a raw, uncorrected value in which the background has not been subtracted out;

(103) Spot Median Intensity: This field is read-only and stores the median signal intensity value(s) of the selected spot(s). This is a raw, uncorrected value in which the background has not been subtracted out;

(104) Spot Standard Deviation: This field is read-only and stores the standard deviation of the signal pixels for the selected spot(s);

(105) Spot Number of Pixels: This field is read-only and stores the number of pixels used to calculate the signal for the selected spot(s);

(106) Spot Total Intensity: This field is read-only and stores the total integrated signal intensity value(s) of the selected spot(s). This is a raw, uncorrected value in which the background has not been subtracted out;

(107) Spot Peak Intensity: This field is read-only and stores the highest signal pixel intensity value for the selected spot(s). This is a raw, uncorrected value in which the background has not been subtracted out;

(108) Background Mean Intensity: This field is read-only and stores the mean background intensity value(s) of the selected spot(s);

(109) Background Median Intensity: This field is read-only and stores the median background intensity value(s) of the selected spot(s);

(110) Background Standard Deviation: This field is read-only and stores the standard deviation of the background pixels for the selected spot(s);

(111) Background Number of Pixels: This field is read-only and stores the number of pixels used to calculate the background for the selected spot(s).

The attributes identified above may be grouped together for convenient display to the researcher as individual dialog boxes, pull-down menus, or tabbed displays. In one embodiment, the array/plate name attribute, array/plate ID attribute, parent ID attribute, images attribute, and comments are grouped together as general information attributes; the X offset attribute, Y offset attribute, columns of multi-sets attribute, rows of multi-sets attribute, multi-set column spacing attribute, columns of sets attribute, rows of sets attribute, set column spacing attribute, set row spacing attribute, columns per set attribute, rows per set attribute, X spacing between Wells attribute, Y spacing between Wells attribute, well diameter attribute, well shape attribute, grid angle attribute, and shape constraint attribute are grouped together as geometry tab attributes; max grid rotation attribute, max set deviation attribute, max spot deviation attribute, max spot deviation attribute, min spot diameter attribute, max spot diameter attribute, and max spot compactness attribute are grouped together as detection tab attributes; treatment attribute, treatment units attribute, time attribute, temperature attribute, and buffer attribute are grouped together as hybridization tab attributes; Cy3 ID attribute, Cy3 cye dye attribute, and Cy3 enzyme attribute are grouped together as Probe_cy3 attributes; Cy5 ID attribute, Cy5 cye dye attribute, and Cy5 enzyme attribute are grouped together as Probe_cy5 attributes.

### EXAMPLE

The following example is intended to be exemplary only and is not intended to limit the scope of the claims.

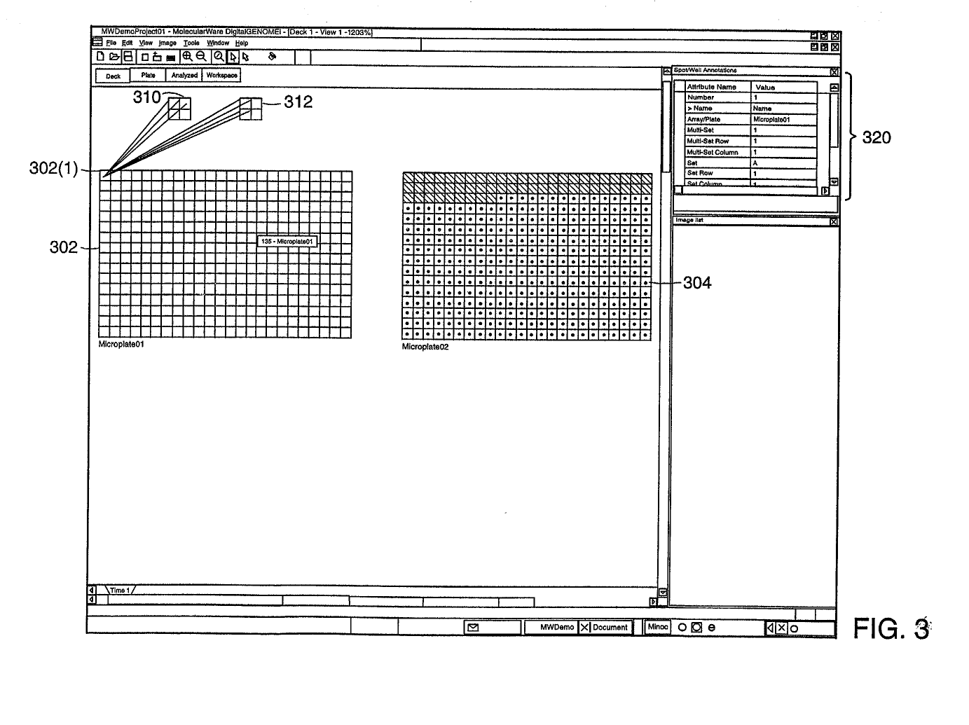

FIG. 3 depicts a screen shot of an embodiment of the invention showing two microplates: microplate01 302 and microplate02 304. One well 302 (1) of microplate01 302 is selected and the screen display indicates that well 302 (1) maps to four spots per microarray 310, 312. As shown in FIG. 3, if a well is mapped to a spot it is displayed in a color other than gray. If a well has not been mapped to a spot, then it is displayed as a gray color (as shown in connection with microplate 02 304). Also shown in FIG. 3 is an annotation window 320 which displays to the researcher the attributes associated with selected well 302 (1). As shown in the embodiment of FIG. 3, the geometrical information associated with well 302 (1) is shown.

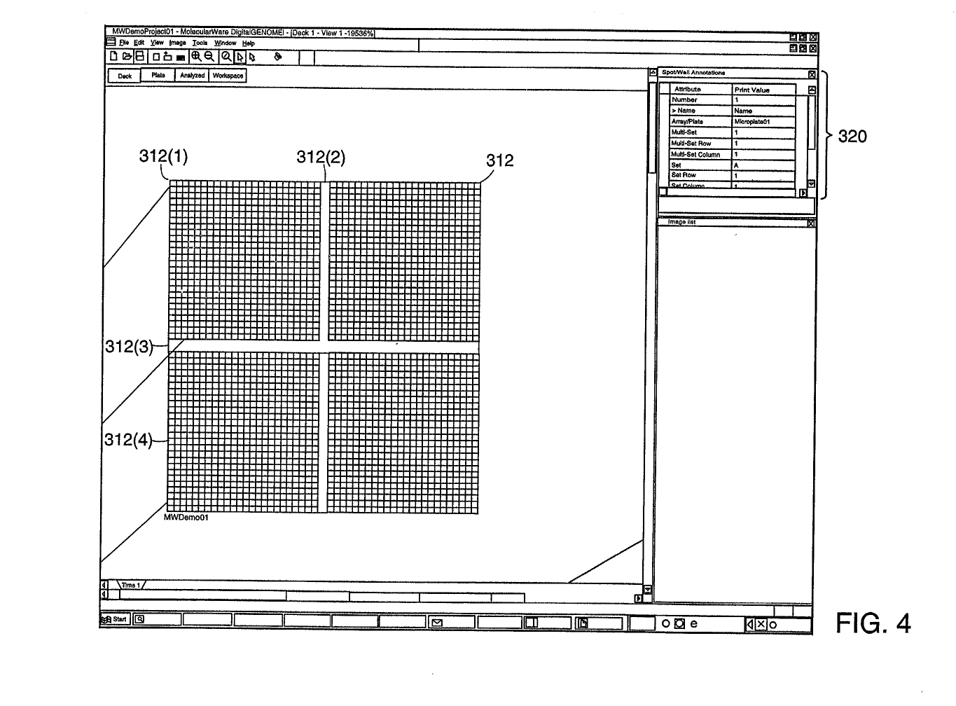

FIG. 4 depicts a closer view of microarray 312 showing that spots 312 (1), 312 (2), 312 (3), 312 (4), are mapped from a particular well. Annotations window 320 displays attribute values associated with the particular spots.

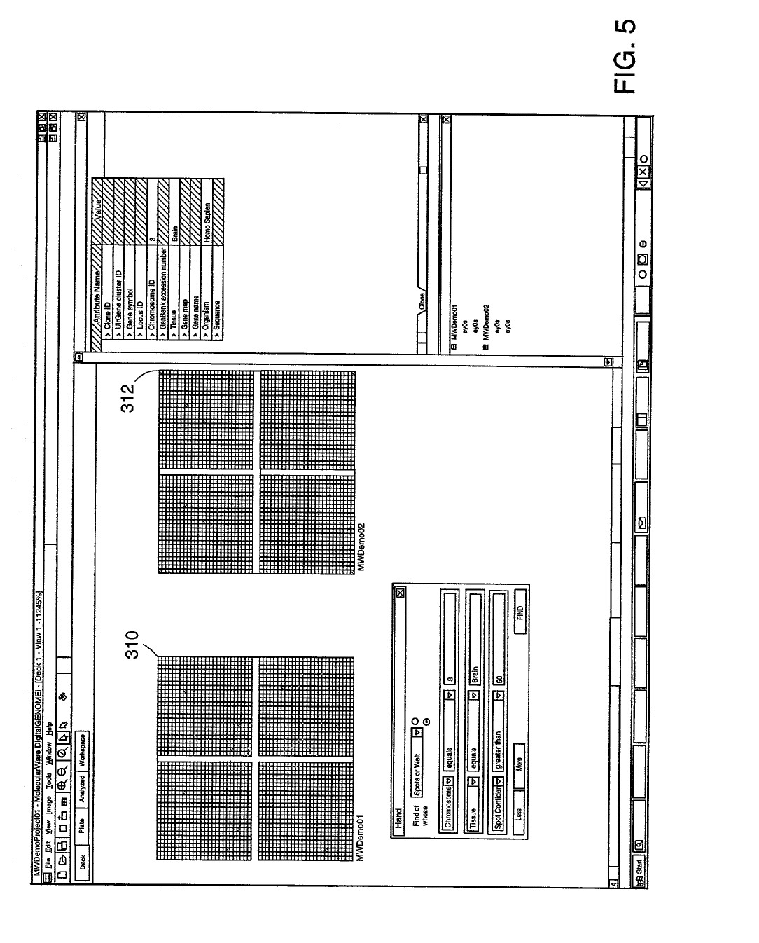

FIG. 5 is a screen shot displaying to a researcher the results of a search performed on the samples represented by microarrays 310, 312 a search dialog box 510 provides a number of pull-down menus and input fields which allows a researcher to tailor a search. As shown in search dialog box 510, the researcher is able to construct a search that finds all spots or wells throughout a project or only for the currently displayed microarrays or microplates. As shown in the embodiment of FIG. 5, the researcher has elected to find both spots and wells throughout the entire project matching the search criteria displayed. As shown in FIG. 5, the researcher has constructed a search looking for all spots having cDNA from chromosome 3, tissue sample from the brain, and a spot confidence exceeding fifty percent. Spots matching the search criteria are displayed to the user in a darker gray than other spots displayed to the user, although any color may be used to display qualifying spots to the researcher.

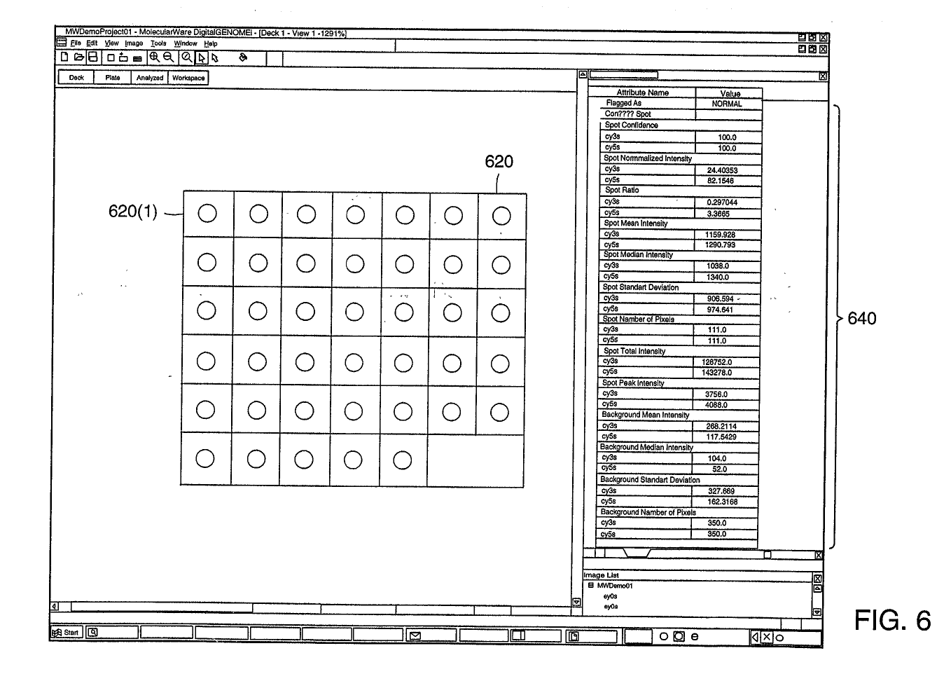

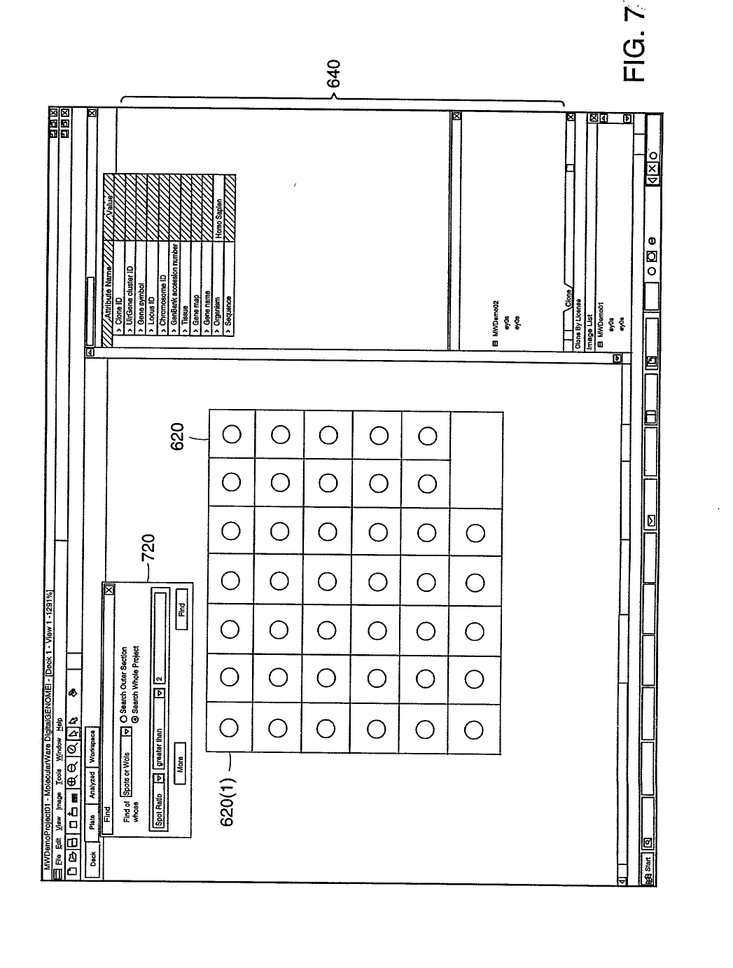

FIG. 6 shows a virtual array 620 created from the spot matching the search criteria of FIG. 5. As shown in the embodiment of FIG. 6, spot 620 (1) has been selected and various attribute values are displayed in the spot/well annotations window 640. FIG. 7 depicts a further query performed on the spots contained in virtual array 620 a search dialog box 720 is depicted in which a researcher is searching for those spots having a spot ratio greater than or equal to 2 (signifying a two-fold change in gene expression). The spots matching the search criteria depicted in search dialog box 720 may be highlighted by various colors or may themselves form a new virtual microarray for further searching or display to the researcher. As shown in FIG. 7, the spot well annotations window 640 depicts clone information corresponding to the selected spot 620 (1). In the embodiment shown in FIG. 7, the spot well annotations page includes a number of tabs (info, clone, intensities) which allows the researcher to select between various collections of data corresponding to the selected spot.

Because of the diversity and facility of modem programming practices, the classes of the present invention may take many different forms. In some embodiments, the classes are compiled binary objects in accord with CORBA, ActiveX, OpenDoc, or other object-oriented frameworks. In still other embodiments, the classes are binary executables compiled from files written in one or more programming languages including but not limited to C, C++, C#, Lisp, or Pascal.

Many alterations and modifications may be made by those having ordinary skill in the art without departing from the spirit and scope of the invention. Therefore, it must be expressly understood that the illustrated embodiment has been shown only for the purposes of example and should not be taken as limiting the invention, which is defined by the following claims. The following claims are thus to be read as not only literally including what is set forth by the claims but also to include all equivalent elements for performing substantially the same function in substantially the same way to obtain substantially the same result, even though not identical in other respects to what is shown and described in the above illustrations.

What is claimed is:

1. A virtual microplate corresponding to a plurality of physical microplates, the virtual microplate comprising:
a first virtual well associated with a first physical well of a first physical microplate; and
a second virtual well associated with a second physical well of a second physical microplate.

2. A method for visualizing data comprising the steps of:
providing a first data array;
providing a second data array;
each of said first and second data arrays comprising a plurality of locations, each of said plurality of locations comprising a plurality of attributes associated with said location; and
generating a virtual data array comprising a plurality of locations, each location associated with a location in said first data array or said second data array, each location comprising plurality of attributes associated with said location on said first and data array.
